(19) United States
(12) Patent Application Publication
(10) Pub. No.: US 2019/0249997 A1
(43) Pub. Date: Aug. 15, 2019

(54) EFFECTIVE SEARCH OF TRAVELLING DATA CORRESPONDING TO MEASURED POSITIONS OF A VEHICLE

(71) Applicant: FUJITSU LIMITED, Kawasaki-shi (JP)

(72) Inventor: Takashi MIURA, Kawasaki (JP)

(73) Assignee: FUJITSU LIMITED, Kawasaki-shi (JP)

(21) Appl. No.: 16/389,429

(22) Filed: Apr. 19, 2019

Related U.S. Application Data
(63) Continuation of application No. PCT/JP2018/000116, filed on Jan. 5, 2018.

(30) Foreign Application Priority Data
Jan. 16, 2017 (JP) 2017-005440

(51) Int. Cl. G01C 21/30; G06F 16/9537; G06F 16/29; G01S 19/13

(52) U.S. Cl. CPC G01C 21/30; G01S 19/13; G06F 16/29; G06F 16/9537

(57) ABSTRACT

An apparatus includes a memory configured to store traveling data items indicating chronological changes in positions of vehicles, in association with first angular information indicating an angle of a first movement direction of a vehicle with respect to a reference direction, where the first movement direction is identified by a pair of positions among first multiple positions indicated by each of the traveling data items. The apparatus acquires positioning data indicating chronological changes in a measured position of a target vehicle, and searches for a target traveling data item corresponding to the positioning data from the memory, based on second multiple positions indicated by the acquired positioning data and second angular information indicating an angle of a second movement direction of the target vehicle with respect to a reference direction, where the second movement direction is identified from a pair of positions among the second multiple positions.

### CROSS-REFERENCE TO RELATED APPLICATION

This application is a continuation application of International Application PCT/JP2018/000116 filed on Jan. 5, 2018 and designated the U.S., the entire contents of which are incorporated herein by reference. The International Application PCT/JP2018/000116 is based upon and claims the benefit of priority of the prior Japanese Patent Application No. 2017-005440, filed on Jan. 16, 2017, the entire contents of which are incorporated herein by reference.

### FIELD

The embodiment discussed herein is related to effective search of travelling data corresponding to measured positions of a vehicle.

### BACKGROUND

There is a technique for identifying a road on which a vehicle has existed based on latitude and longitude data measured by a global positioning system (GPS) sensor attached to the vehicle. This technique is referred to as map matching. To analyze road states at locations, latitude and longitude data of a large number of vehicles is accumulated in a server and map matching is executed on the latitude and longitude data aggregated by batch processing or the like.

As a related-art technique, there is a technique for executing map matching to match a GPS position of a vehicle with a road or intersection on a city map and determine a final current position of the vehicle, and displaying a vehicle mark at the determined current position on a city map image based on the determined current position so that the vehicle mark overlaps the determined current position.

An example of related art is Japanese Laid-open Patent Publication No. 2001-41754.

### SUMMARY

According to an aspect of the embodiments, an apparatus includes a memory configured to store traveling data items indicating chronological changes in positions of vehicles, in association with first angular information indicating an angle of a first movement direction of a vehicle with respect to a reference direction, where the first movement direction is identified by a pair of positions among first multiple positions indicated by each of the traveling data items. The apparatus acquires positioning data indicating chronological changes in a measured position of a target vehicle, and searches for a target traveling data item corresponding to the positioning data from the memory, based on positions indicated by the acquired positioning data and second angular information indicating an angle of a second movement direction of the target vehicle with respect to the reference direction, where the second movement direction is identified from a pair of positions among the second multiple positions indicated by the positioning data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram describing an example of an information processing method according to an embodiment;

FIG. 2 is an explanatory diagram illustrating an example of a configuration of an information processing system;

FIG. 3 is a block diagram illustrating an example of a hardware configuration of an information processing device;

FIG. 4 is a block diagram illustrating an example of a hardware configuration of each of terminal devices;

FIG. 5 is an explanatory diagram illustrating an example of details stored in a high-accuracy MM result DB;

FIG. 6 is an explanatory diagram illustrating a specific example of positioning data;

FIG. 7 is a block diagram illustrating an example of a functional configuration of the information processing device;

FIGS. 8A and 8B are explanatory diagrams illustrating relationships between the magnitude of a vector and a positioning error;

FIG. 9 is a diagram describing an example of the search of a traveling data item;

FIG. 10 is an explanatory diagram illustrating a specific example of map matching data;

FIG. 11 is a flowchart illustrating an example of a preprocess procedure of the information processing device;

FIG. 12 is a flowchart illustrating an example of a real-time process procedure of the information processing device;

FIG. 13 is a first flowchart illustrating an example of a specific process procedure for a range search process;

FIG. 14 is a second flowchart illustrating the example of the specific process procedure for the range search process;

FIG. 15 is a third flowchart illustrating the example of the specific process procedure for the range search process; and

FIG. 16 is a flowchart illustrating an example of a specific process procedure for a similarity search process.

### DESCRIPTION OF EMBODIMENTS

In the related-art techniques, in map matching, since the number of traveling data items to be used to execute crosschecking with positioning data measured using a satellite positioning system such as a GPS and determine similarities or the like may be large, it may take long time to execute a process of identifying a road on which a vehicle has existed and a load may be applied to the process. When it takes long time to execute the process of identifying the road on which the vehicle has existed and the load is applied to the process, it is difficult to execute the map matching in real time.

Hereinafter, an embodiment of an information processing device disclosed herein, an information processing system disclosed herein, an information processing method disclosed herein, and an information processing program disclosed herein is described in detail with reference to the accompanying drawings.

### EMBODIMENT

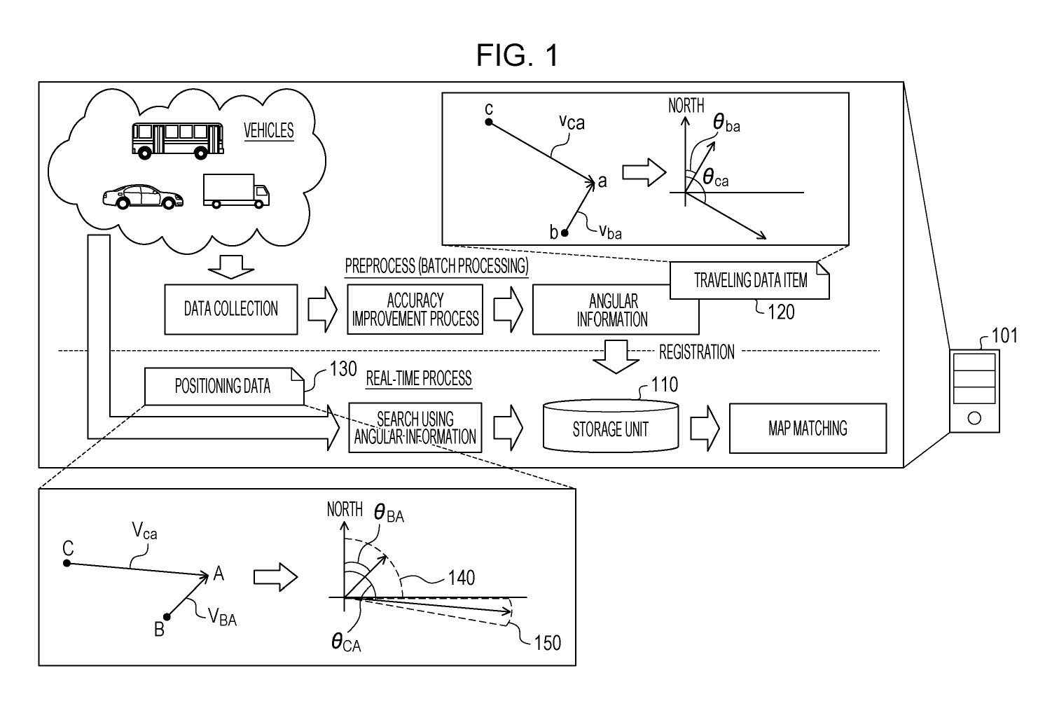

FIG. 1 is a diagram describing an example of an information processing method according to the embodiment. In FIG. 1, an information processing device 101 is a computer that includes a storage unit 110 and is configured to search for a traveling data item corresponding to positioning data indicating chronological changes in a measured position.

The positioning data is, for example, information indicating the chronological changes in the position measured using a satellite positioning system. The satellite positioning system is configured to measure a position using radio waves (signals) from multiple satellites (positioning satellites). The satellite positioning system is a GPS, a quasi-zenith satellite system, or the like, for example.

The traveling data item is information indicating chronological changes in the position of a vehicle. The vehicle is an ordinary car, a light car, a bus, a truck, a motorbike, or the like that travels on a road. For example, the traveling data item is obtained by executing a correction process (accuracy improvement process) of removing an error on the positioning data (latitude and longitude data) that has been measured using the satellite positioning system and indicates the position of the vehicle.

The error is a positioning error caused due to effects of the positions, varying from hour to hour, of the multiple satellites, multipath, the ionosphere, the troposphere, and the like. The position after the correction process is, for example, a highly accurate position that is obtained by executing the correction process of removing an error caused due to the effects of multipath, the ionosphere, the troposphere, and the like, based on an error deviation caused due to dilution of precision (DOP) that depends on the positions of the multiple satellites. As a method for removing an error from a position measured using the satellite positioning system, any existing method may be used.

It is considered that GPS sensors are attached to various vehicles that travel on a road, positioning data acquired by the GPS sensors is aggregated into a server, and map matching (MM) is executed to identify road states at locations in real time and reflect the identified road states in traffic information. The map matching is a process of identifying a road on which a vehicle has existed, based on positioning data of the GPS or the like.

As a method for executing the map matching using positioning data (latitude and longitude data) of a large number of vehicles, a process to be executed using a similarity search is considered. This process is executed at a speed that enables the map matching to be executed in real time, while identifying a road on which a vehicle has existed, with high accuracy.

The similarity search is not executed to completely match a value of a target to be searched for with a key targeted for the search. The similarity search is executed to search for a value close to a target to be searched for, from data targeted for the search. As an example of the similarity search, there is a technique for using Euclidean distances to calculate distances between a value of data targeted for a search and targets to be searched for, and acquiring a target that is to be searched for and is the closest in distance to the data targeted for the search.

However, in the map matching process using the similarity search, as the number of candidate records to which records are narrowed down by a range search is larger, a time period for similarity calculation (for example, distance calculation) is longer and a load caused by the similarity calculation is higher. For example, in the case where a traveling data item corresponding to positioning data is to be searched for by the range search, a traveling data item indicating a movement direction different from that of the positioning data may be searched for. When a time period for similarity calculation that tends to cause the largest cost during an entire process is long and a load caused by the similarity calculation is high, it is difficult to execute a real-time process on a fixed number of vehicles or more.

For example, the range search is executed to set a certain search range and search for a traveling data item including the position of a vehicle in the search range, from a group of traveling data items indicating the positions of the vehicles that travel on roads. As the search range, a range including any of positions (for example, latest position) indicated by the positioning data is set.

The first embodiment describes an information processing method of calculating, in a “preprocess”, angular information indicating movement directions of traveling data items, and narrowing down, in a “real-time process”, the traveling data items to traveling data items to be used for the similarity search from angular information indicating a movement direction of positioning data. An example of a process to be executed by the information processing device 101 is described below.

Preprocess

The information processing device 101 calculates angular information indicating an angle of a movement direction dr identified by a pair of positions among multiple positions indicated by each of traveling data items with respect to a reference direction, based on the traveling data items indicating chronological changes in the position of a vehicle. As described above, the traveling data items are obtained by executing the correction process (accuracy improvement process) of removing an error from positioning data indicating the position, measured using the satellite positioning system, of the vehicle.

For example, the traveling data items are array data (or sequences of points) indicating positions (latitudes and longitudes), after the correction process, of multiple points measured at predetermined time intervals by the satellite positioning system. Each of the movement directions dr may be expressed by a vector v extending from a position (hereinafter referred to as “fourth position”) among multiple positions indicated by a traveling data item to another position (hereinafter referred to as “third position”) among the multiple positions indicated by the traveling data item.

The fourth position is measured before the measurement of the third position. The third position is, for example, the latest position among the multiple positions indicated by the traveling data item. For example, the fourth position is among the multiple positions indicated by the traveling data item and may be measured immediately before the measurement of the third position or may be the oldest position among the multiple positions indicated by the traveling data item. The reference direction may be an arbitrarily set direction. For example, the reference direction is set at a direction extending toward the true north.

In the example illustrated in FIG. 1, a vector v_{ba} extending from a point b to a point a and a vector v_{ca} extending from a point c to the point a are indicated in a traveling data item 120. The point a indicates the latest position among multiple positions indicated by the traveling data item 120. The point b is among the multiple positions indicated by the traveling data item 120 and is measured immediately before the measurement of the point a. The point c indicates the oldest position among the multiple positions indicated by the traveling data item 120. The point a corresponds to the third position. Each of the points b and c corresponds to the fourth position.

The vector v_{ba} connects the two chronologically continuous points to each other and may indicate a local movement direction dr indicated by the traveling data item 120. The vector v_{ca} connects the two points, which are the most chronologically distant from each other, to each other and indicates a global (entire) movement direction dr indicated by the traveling data 120.

In the example illustrated in FIG. 1, the reference direction is set at the “direction extending toward the true north”. Thus, an angle of the vector v_{ba} with respect to the reference direction is an angle θ_{ba} formed between the vector v_{ba} and the direction extending toward the true north through the point b. An angle of the vector v_{ca} with respect to the reference direction is an angle θ_{ca} formed between the vector v_{ca} and the direction extending toward the true north through the point c.

The information processing device 101 associates each of traveling data items with angular information indicating an angle of a movement direction identified from a pair of positions among multiple positions indicated by the traveling data item with respect to the reference direction, and stores the traveling data item and the angular information in the storage unit 110. In the example illustrated in FIG. 1, the traveling data item 120 and angular information indicating the angles θ_{ba} and θ_{ca} are associated with each other and stored in the storage unit 110.

Thus, the angle θ_{ba} of the vector v_{ba} indicating the local movement direction dr indicated by the traveling data item 120 with respect to the reference direction and the angle θ_{ca} of the vector v_{ca} indicating the global movement direction dr indicated by the traveling data item 120 with respect to the reference direction may be associated with the traveling data item 120 and registered in the storage unit 110.

Real-Time Process

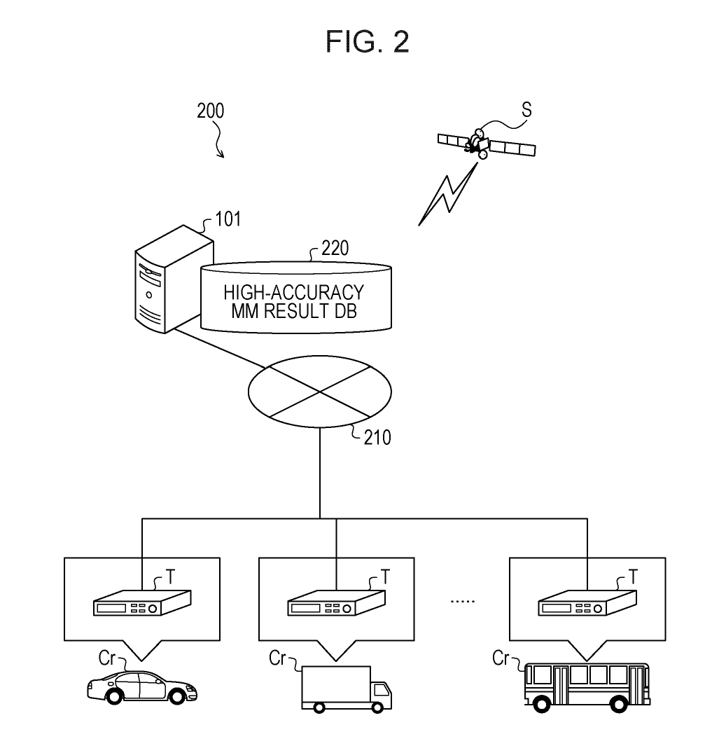

The information processing device 101 acquires positioning data 130. The positioning data 130 is information indicating chronological changes in a measured position. For example, the positioning data 130 is array data (or a sequence of points) indicating the positions of multiple positioning points measured using the satellite positioning system at predetermined time intervals. For example, the information processing device 101 acquires, from a terminal device (for example, a terminal device T illustrated in FIG. 2 described later) attached to a vehicle, the positioning data 130 indicating the chronological changes in the position measured using the satellite positioning system.

Next, the information processing device 101 calculates angular information, based on the acquired positioning data 130. The angular information indicates an angle of a movement direction DR identified from a pair of positions among the multiple positions indicated by the positioning data 130 with respect to the reference direction. The movement direction DR may be expressed by a vector V extending from a position (hereinafter referred to as “second position”) among the multiple positions indicated by the positioning data 130 to another position (hereinafter referred to as “first position”) among the multiple positions indicated by the positioning data 130.

The second position is measured before the measurement of the first position. The first position is, for example, the latest position among the multiple positions indicated by the positioning data 130. For example, the second position is among the multiple positions indicated by the positioning data 130 and may be measured immediately before the measurement of the first position or may be the oldest position among the multiple positions indicated by the positioning data 130.

In the example illustrated in FIG. 1, a vector V_{BA} extending from a point B to a point A and a vector V_{CA} extending from a point C to the point A are illustrated. The point A indicates the latest position among the multiple positions indicated by the positioning data 130. The point B is among the multiple positions indicated by the positioning data 130 and is measured immediately before the measurement of the point A. The point C indicates the oldest position among the multiple positions indicated by the positioning data 130. The point A corresponds to the first position. Each of the positions B and C corresponds to the second position.

The vector V_{BA} connects the chronologically continuous two points to each other and indicates a local movement direction DR indicated by the positioning data 130. The vector V_{CA} connects the two points, which are the most chronologically distant from each other, to each other and indicates a global movement direction DR indicated by the positioning data 130.

In the example illustrated in FIG. 1, the reference direction is set at the “direction extending toward the true north”. Thus, an angle of the vector V_{BA} with respect to the reference direction is an angle θ_{BA} formed between the vector V_{BA} and the direction extending toward the true north through the point B. An angle of the vector V_{CA} with respect to the reference direction is an angle θ_{CA} formed between the vector V_{CA} and the direction extending toward the true north through the point C.

The information processing device 101 searches for a traveling data item corresponding to the positioning data 130 from the storage unit 110, based on the positions indicated by the positioning data 130 and the angular information. For example, the information processing device 101 executes the range search based on the positions indicated by the positioning data 130 to extract traveling data items from the storage unit 110. Then, the information processing device 101 searches for the traveling data item corresponding to the positioning data 130 from the traveling data items obtained by the range search, based on the calculated angular information.

In the example illustrated in FIG. 1, the information processing device 101 sets an angular range 140, based on the angle θ_{BA} of the vector V_{BA} with respect to the reference direction. For example, the information processing device 101 may set a range of equal to or larger than “θ_{BA}−θ′_{BA}” and equal to or smaller than “θ_{BA}−θ′_{BA}” as the angular range 140. θ′_{BA} may be set at an arbitrary angle. For example, θ′_{BA} is set at an angle of 45 degrees or the like.

In this case, the information processing device 101 searches for, from the traveling data items obtained by the range search, a traveling data item in which an angle θ_{ba} of a vector v_{ba} with respect to the reference direction is in the angular range 140. Thus, the traveling data item indicating a local movement direction similar to the local movement direction indicated by the positioning data 130 may be searched for.

As an example, θ_{BA} of the positioning data 130 is set at “45 degrees”, a range equal to or larger than “0 degrees” and equal to or smaller than “90 degrees” is set as the angular range 140, the traveling data item 120 is included in the traveling data items obtained by the range search, and θ_{ba} of the traveling data item 120 is set at “60 degrees”. In this case, since θ_{ba} of the traveling data item 120 is in the angular range 140, the traveling data item 120 is searched for.

The information processing device 101 sets an angular range 150, based on the angle θ_{CA} of the vector V_{CA} with respect to the reference direction. For example, the information processing device 101 may set a range equal to or larger than “θ_{CA}−θ′_{CA} and equal to or smaller than “θ_{CA}+θ′_{CA}” as the angular range 150. θ′_{CA} may be set at an arbitrary angle. For example, θ′_{CA} is set at an angle of 10 degrees or the like.

In this case, the information processing device 101 searches for, from the traveling data items obtained by the range search, a traveling data item in which an angle θ_{ca} of a vector v_{ca} with respect to the reference direction is in the angular range 150. Thus, the traveling data item indicating a global movement direction similar to that of the positioning data 130 may be searched for.

As an example, θ_{CA} of the positioning data 130 is set at “95 degrees”, the angular range 150 is set at a range equal to or larger than “90 degrees” and equal to or smaller than “100 degrees”, the traveling data item 120 is included in the traveling data items obtained by the range search, and θ_{ca} of the traveling data item 120 is “120 degrees”. In this case, since θ_{ca} of the traveling data item 120 is not in the angular range 150, the traveling data item 120 is not searched for.

The information processing device 101 may search for either a traveling data item indicating that an angle θ_{ba} is in the angular range 140 or a traveling data item indicating that an angle θ_{ca} is in the angular range 150. The information processing device 101 may search for a traveling data item indicating that an angle θ_{ba} is in the angular range 140 and that an angle θ_{ca} is in the angular range 150.

In this manner, the information processing device 101 may search for a traveling data item corresponding to a movement direction DR identified from a pair of positions among the multiple positions indicated by the positioning data 130. For example, the information processing device 101 may search for a traveling data item indicating a local movement direction and a global movement direction that are similar to those of the positioning data 130. Then, the information processing device 101 may execute a similarity search using a searched traveling data item, thereby identifying a road corresponding to the positions indicated by the positioning data 130.

In this case, traveling data items indicating movement directions largely different from that of the positioning data 130 are excluded. For example, a pointless traveling data item, which is not selected in the similarity search, is excluded based on traveling behaviors (movement directions) of the vehicles in advance. Thus, it may be possible to reduce a time period required for the similarity calculation that tends to cause the largest cost during the entire process, reduce a load caused by the similarity calculation, and increase the number of vehicles to be processed in real time.

A process of using a traveling data item searched for by the information processing device 101 to identify the road corresponding to the positions indicated by the positioning data 130 may be executed by a computer different from the information processing device 101. The example in which the positioning data 130 is information indicating the positions measured using the satellite positioning system is described above. The embodiment, however, is not limited to this. For example, positioning data indicating positions measured using access points of a wireless local area network (LAN) that are located in sites may be used. The case where the GPS sensors or the like are attached to the vehicles that travel on the road is described above. The embodiment, however, is not limited to this. For example, the GPS sensors or the like may be attached to drones (unmanned aircraft vehicles) for flying along a route in the air and may obtain positioning data.

(Example of Configuration of Information Processing System 200)

Next, an example of a configuration of an information processing system 200 according to the embodiment is described. The following describes an example in which a GPS is used as the satellite positioning system.

FIG. 2 is an explanatory diagram illustrating the example of the configuration of the information processing system 200. In FIG. 2, the information processing system 200 includes the information processing device 101 and multiple terminal devices T. In the information processing system 200, the information processing device 101 and the multiple terminal devices T are coupled to each other via a wired or wireless network 210. The network 210 is, for example, the Internet, a mobile communication network, a LAN, a wide area network (WAN), or the like.

The information processing device 101 includes a high-accuracy MM result database (DB) 220 and is configured to identify a road corresponding to the positions, measured using the GPS, of vehicles Cr (terminals T). The GPS is an example of the satellite positioning system and is configured to measure a position using radio waves from multiple satellites S (only one satellite is illustrated in FIG. 2). Each of the vehicles Cr is an example of a moving body. For example, the vehicles Cr are ordinary cars, light cars, buses, trucks, motorbikes, or the like.

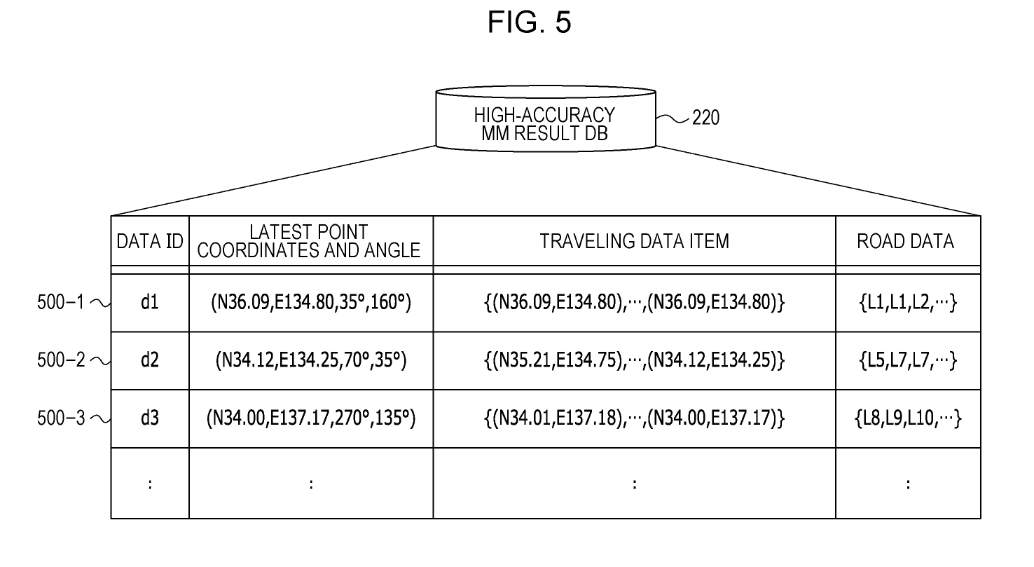

The high-accuracy MM result DB 220 corresponds to the storage unit 110 illustrated in FIG. 1. Details stored in the high-accuracy MM result DB 220 are described later with reference to FIG. 5.

The terminal devices T are computers configured to use the GPS including the multiple satellites S to measure the positions of the terminal devices T (vehicles Cr). For example, the terminal devices T transmit positioning data D indicating chronological changes in the positions, measured at predetermined time intervals (of, for example, 10 seconds), of the vehicles Cr to the information processing device 101 periodically (for example, at time intervals of 5 minutes).

The terminal devices T may be applied to digital tachographs. The terminal devices T may be enabled by car navigation systems, smartphones, tablet personal computers (PCs), or the like, for example.

(Example of Hardware Configuration of Information Processing Device 101)

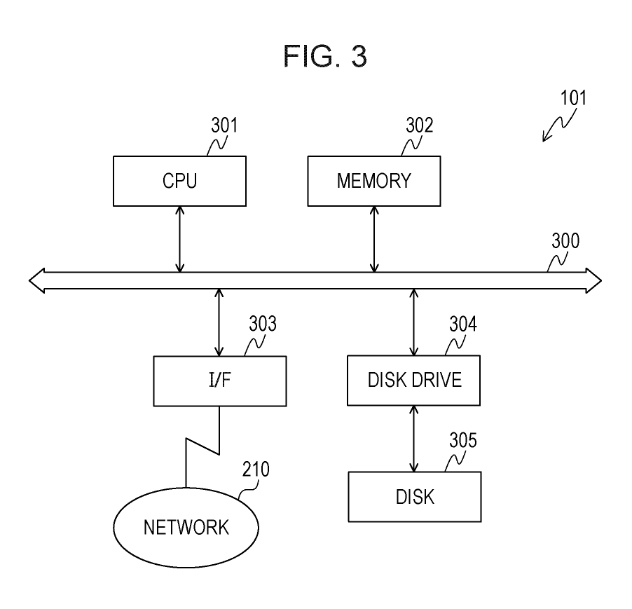

FIG. 3 is a block diagram illustrating an example of a hardware configuration of the information processing device 101. In FIG. 3, the information processing device 101 includes a central processing unit (CPU) 301, a memory 302, an interface (I/F) 303, a disk drive 304, and a disk 305. The units 301 to 304 are connected to each other via a bus 300.

The CPU 301 controls the entire information processing device 101. The memory 302 includes a read only memory (ROM), a random access memory (RAM), and a flash ROM, for example. For example, the flash ROM and the ROM store various programs, while the RAM is used as a work area of the CPU 301. The programs stored in the memory 302 are loaded into the CPU 301, and coded processes are executed by the CPU 301.

The I/F 303 is coupled to the network 210 via a communication line or link and coupled to external computers (for example, the terminal devices T illustrated in FIG. 2) via the network 210. The I/F 303 serves as an interface between the network 210 and the inside of the information processing device 101 and controls the input and output of data from and to the external computers. As the I/F 303, a modem, a LAN adapter, or the like may be used, for example.

The disk drive 304 controls the reading and writing of data from and to the disk 305 in accordance with control by the CPU 301. The disk 305 stores data written in accordance with control by the disk drive 304. As the disk 305, a magnetic disk, an optical disc, or the like may be used, for example.

The information processing device 101 may further include a solid state drive (SSD), an input device, a display, and the like, as well as the aforementioned constituent units.

(Example of Hardware Configurations of Terminal Devices T)

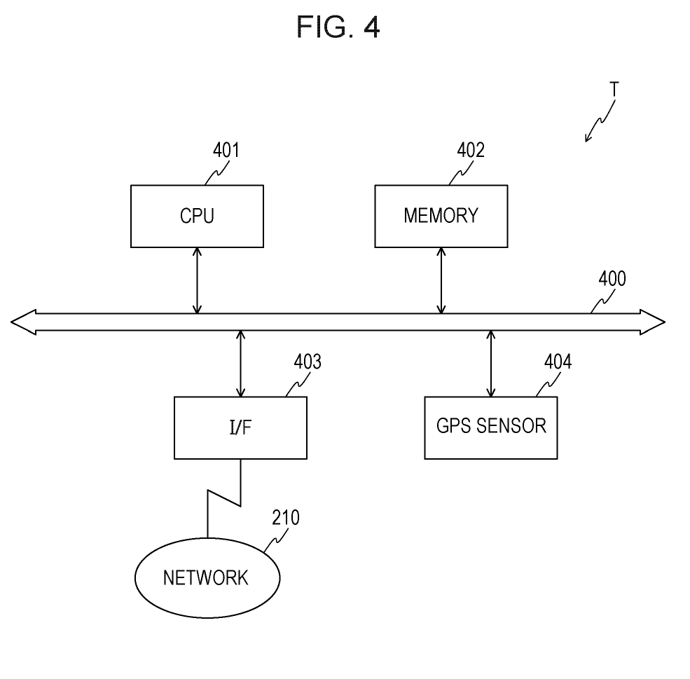

FIG. 4 is a block diagram illustrating an example of a hardware configuration of each of the terminal devices T. In FIG. 4, each of the terminal devices T includes a CPU 401, a memory 402, an I/F 403, and a GPS sensor 404. The constituent units 401 to 404 are connected to each other via a bus 400.

The CPU 401 controls the entire terminal device T. The memory 402 includes a ROM, a RAM, and a flash ROM, for example. For example, the flash ROM and the ROM store various programs, while the RAM is used as a work area of the CPU 401. The programs stored in the memory 402 are loaded into the CPU 401, and coded processes are executed by the CPU 401.

The I/F 403 is coupled to the network 210 via a communication line or link and coupled to an external computer (for example, the information processing device 101) via the network 210. The I/F 403 serves as an interface between the network 210 and the inside of the terminal device T and controls the input and output of data from and to the external computer.

The GPS 404 receives radio waves from the satellites S (refer to FIG. 2) of the GPS and outputs positioning data indicating the position of the terminal device T (vehicle Cr). The positioning data is information identifying a single point existing on the earth and identified by a latitude and a longitude, for example. Each of the terminal devices T may include a disk drive, a disk, an SSD, an input device, and a display, as well as the aforementioned constituent units.

(Details Stored in High-Accuracy MM Result DB 220)

Next, details stored in the high-accuracy MM result DB 220 included in the information processing device 101 are described. The high-accuracy MM result DB 220 is enabled by a storage device such as the memory 302, the disk 305, or the like of the information processing device 101 illustrated in FIG. 3.

FIG. 5 is an explanatory diagram illustrating an example of the details stored in the high-accuracy MM result DB 220. In FIG. 5, the high-accuracy MM result DB 220 includes fields for data IDs, latest coordinates and angles, traveling data items, and road data. High-accuracy MM results (for example, high-accuracy MM results 500-1 to 500-3) are stored as records by setting information in the fields.

The data IDs are identifiers uniquely identifying traveling data items. Latest point coordinates indicated in the field for latest point coordinates and angles are coordinates (latitude and longitude data) of the latest positioning point p_{N} among a number N of positioning points p₁ to p_{N} included in each of the traveling data items. In the following description, “N” of a positioning point p_{N} is “30” in some cases.

Angles indicated in the field for latest point coordinates and angles indicate local angles (“local angles θ_{ba}” described later) of the traveling data items and global angles (“global angles θ_{ca}” described later) of the traveling data items. The local angles are angles of vectors indicating local movement directions indicated by the traveling data items with respect to the reference direction. The global angles are angles of vectors indicating global (entire) movement directions indicated by the traveling data items with respect to the reference direction.

Each of the traveling data items is a latitude and longitude data array indicating chronological changes in the position of a vehicle Cr that has traveled on a road. For example, each of the traveling data items is obtained by placing, in chronological order, coordinates (latitude and longitude data indicating the positions of the vehicles Cr) of 30 positioning points p₁ to p₃₀ measured using the GPS at predetermined time intervals (of, for example, 10 seconds). Coordinates of positioning points p₁ to p₃₀ indicated by each of the traveling data items are latitude and longitude data indicating the position of the vehicle Cr after the correction process (high-accuracy MM process) of removing an error caused by effects of the positions, varying from hour to hour, of the multiple satellites S, multipath, the ionosphere, the troposphere, and the like.

The road data is road ID arrays indicating roads associated with coordinates of positioning points p₁ to p₃₀ included in the traveling data items (latitude and longitude data arrays). For example, the road data is obtained by chronologically placing road IDs identifying roads associated with coordinates of 30 (N=30) positioning points p₁ to p₃₀ included in each of the traveling data items. The roads associated with the coordinates of the positioning points p₁ to p₃₀ are identified by executing the map matching on the positioning points p₁ to p₃₀.

In the following description, an arbitrary traveling data item is referred to as “traveling data item d” in some cases, and road data associated with the traveling data item d is referred to as “road data st” in some cases.

(Example of Positioning Data D)

Next, an example of positioning data D to be transmitted from a terminal device T to the information processing device 101 periodically (for example, at time intervals of 5 minutes) is described.

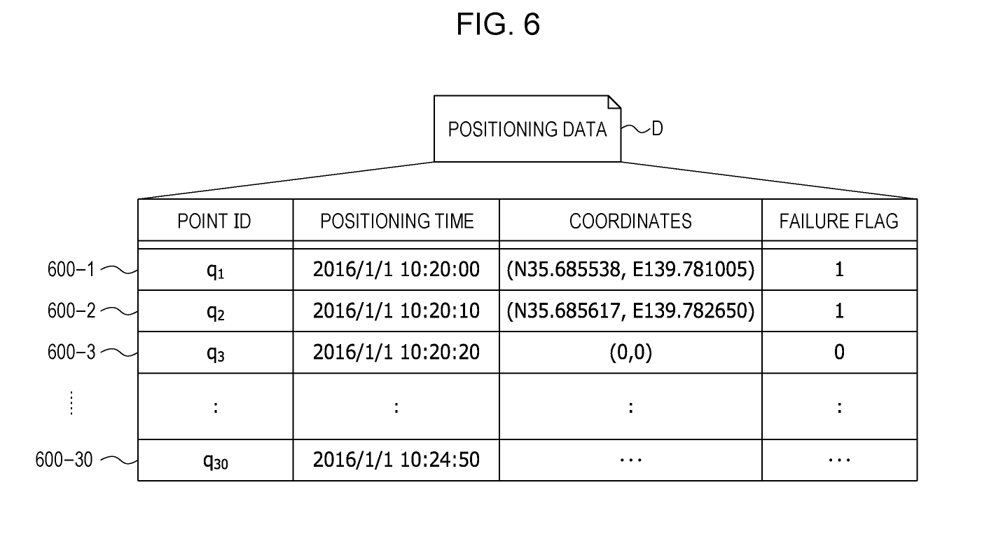

FIG. 6 is an explanatory diagram illustrating an example of the positioning data D. In FIG. 6, the positioning data D is information chronologically indicating coordinates (latitudes and longitudes) of a number N (N=30 in this example) of positioning points q₁ to q₃₀ measured using the GPS at time intervals of 10 seconds and includes positional information 600-1 to 600-30. The positioning data D may be arbitrarily set so that the positioning data D includes any number of positioning points.

The positioning information 600-1 to 600-30 indicates point IDs, positioning times, coordinates, and failure flags that are associated with each other. The point IDs are identifiers identifying the positioning points q. The positioning times are times and dates when the positions of the positioning points q have been measured. The coordinates indicate the positions (latitudes and longitudes) of the positioning points q.

The failure flags indicate whether each of the positions of the positioning points q has not been measured due to a failure such as a unreceived radio wave from a satellite S. A failure flag “1” indicates that the position of a vehicle Cr has been measured. A failure flag “0” indicates that the position of the vehicle Cr has not been measured. When a failure flag for a positioning point q indicates “0”, (0, 0) is set as coordinates of the positioning point q.

The positioning data D may include identification information identifying the vehicle Cr or the terminal device T attached to the vehicle Cr. The positioning data D corresponds to the positioning data 130 illustrated in FIG. 1, for example.

Example of Functional Configuration of Information Processing Device 101

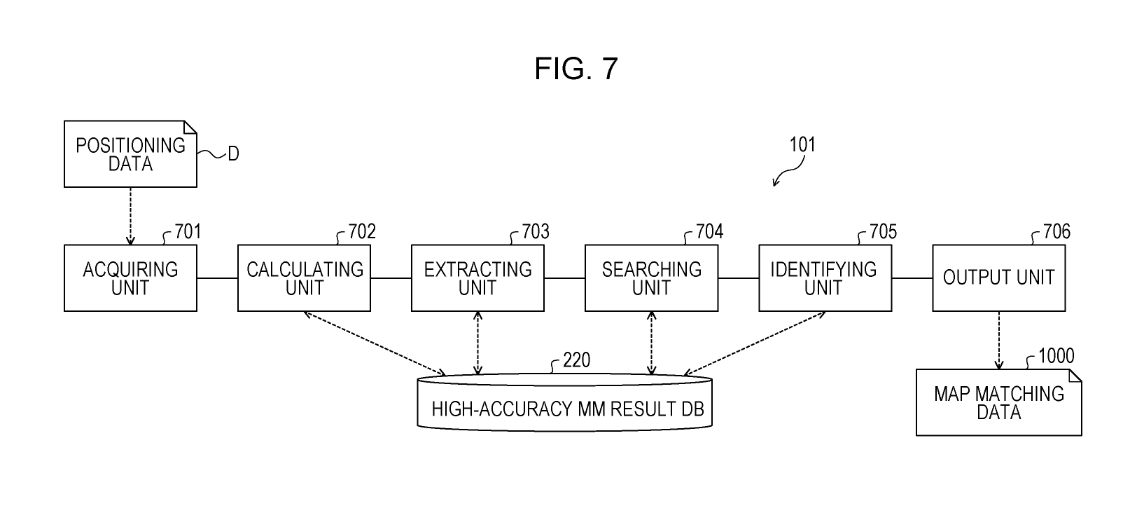

FIG. 7 is a block diagram illustrating an example of a functional configuration of the information processing device 101. In FIG. 7, the information processing device 101 includes an acquiring unit 701, a calculating unit 702, an extracting unit 703, a searching unit 704, an identifying unit 705, and an output unit 706. The acquiring unit 701, the calculating unit 702, the extracting unit 703, the searching unit 704, the identifying unit 705, and the output unit 706 are functions serving as a controller. For example, the functions are enabled by causing the CPU 301 to execute a program stored in a storage device such as the memory 302 illustrated in FIG. 3 or the disk 305 illustrated in FIG. 3 or by the I/F 303. Results of processes executed by the functional units are stored in the storage device such as the memory 302, the disk 305, or the like, for example.

<Preprocess>

First, functional units related to the preprocess are described. The preprocess is a process to be executed before the real-time process.

The acquirer 701 acquires a traveling data item d and road data st associated with the traveling data item d. The traveling data item d is a latitude and longitude data array indicating chronological changes in the position of a vehicle Cr that has traveled on roads. For example, the traveling data item d is obtained by chronologically placing coordinates of 30 (N=30) positioning points p₁ to p₃₀ measured using the GPS at predetermined time intervals. The coordinates of the positioning points p₁ to p₃₀ that are indicated by the traveling data item d are latitude and longitude data indicating the position of the vehicle Cr and subjected to the correction process (high-accuracy MM process) of removing an error.

The road data st is information indicating the roads associated with the positions of the vehicle Cr. For example, the road data st is obtained by chronologically placing road IDs identifying the roads associated with the coordinates of the 30 positioning points p₁ to p₃₀ included in the traveling data item d. The roads associated with the coordinates of the positioning points p₁ to p₃₀ are identified by executing the map matching on the positioning points p₁ to p₃₀.

For example, the acquiring unit 701 may receive and acquire the traveling data item d and the road data st from an external computer via the I/F 303. For example, the acquiring unit 701 may acquire the traveling data item d and the road data st by an operation input by a user using an input device not illustrated.

The acquired traveling data item d and the acquired road data st are stored in the high-accuracy MM result DB 220 illustrated in FIG. 5, for example. As a result, a new high-accuracy MM result to which a data ID is added is stored as a record in the high-accuracy MM result DB 220. At this time, an angle has yet to be set in the field for latest point coordinates and angle.

The traveling data item d and the road data st may be generated by the information processing device 101. For example, the information processing device 101 may acquire, from a terminal device T, positional information indicating positioning time and the position, measured using the GPS, of the vehicle Cr, execute the correction process of removing an error from the position indicated by the positional information, and generate the traveling data item d. The information processing device 101 may use the generated traveling data item d to execute the map matching process and generate the road data st.

The calculator 702 calculates an angle of a movement direction (corresponding to the “movement direction dr” illustrated in FIG. 1) identified from a pair of positions among the multiple positions indicated by the acquired traveling data item d with the reference direction. For example, the calculator 702 acquires coordinate values of latitude and longitudes of points a, b, and c from the traveling data item d.

The point a is, for example, the latest positioning point p₃₀ among the positioning points p₁ to p₃₀ included in the traveling data item d (N=30). The point b is among the positioning points p₁ to p₃₀ included in the traveling data item d and is, for example, the positioning point p₂₉ measured immediately before the measurement of the point a included in the traveling data item d. The point c is, for example, the oldest positioning point p₁ among the positioning points p₁ to p₃₀ included in the traveling data item d. Arbitrary points among the positioning points p₁ to p₃₀ included in the traveling data item d may be set as the points a, b, and c.

Then, the calculator 702 calculates an angle of a vector v_{ba} extending from the point b to the point a with respect to the reference direction, based on coordinate values of latitude and longitudes of the acquired points a and b. The calculator 702 calculates an angle of a vector v_{ca} extending from the point c to the point a with respect to the reference direction, based on coordinate values of latitudes and longitudes of the acquired points a and c. The reference direction may be set at an arbitrary direction. For example, the reference direction is set at the direction extending toward the true north.

The calculated local angle θ_{ba} and the calculated global angle θ_{ca} are set as a high-accuracy MM result in the high-accuracy MM result DB 220. For example, the calculated local angle θ_{ba} and the calculated global angle θ_{ca} are set in the field for latest point coordinates and angle as the high-accuracy MM result associated with the data ID of the traveling data item d.

Thus, the angle (local angle θ_{ba}) of the vector v_{ba} indicating a local movement direction indicated by the traveling data item d with respect to the reference direction and the angle (global angle θ_{ca}) of the vector v_{ca} indicating a global movement direction indicated by the traveling data item d with respect to the reference direction may be associated with the traveling data item d and registered in the high-accuracy MM result DB 220.

<Real-Time Process>

Next, functional units related to the real-time process are described.

The acquiring unit 701 acquires the positioning data D indicating chronological changes in the position measured using the GPS. For example, the acquiring unit 701 acquires the positioning data D by receiving, from the terminal device T attached to the vehicle Cr, the positioning data D indicating the chronological changes in the position, measured using the GPS, of the vehicle Cr.

The positioning data D is array data chronologically indicating the coordinates of the 30 positioning points q₁ to q₃₀ (positions of the vehicle Cr) measured using the GPS at the predetermined time intervals, as illustrated in FIG. 6. Each of the predetermined time intervals is set at an arbitrary value. For example, each of the predetermined time intervals are set at 10 seconds or the like.

The calculating unit 702 calculates an angle of a movement direction (corresponding to the “movement direction DR” described with reference to FIG. 1) identified from a pair of positions among the multiple positions indicated by the acquired positioning data D with respect to the reference direction. For example, the calculating unit 702 acquires coordinate values of latitudes and longitudes of points A, B, and C from the positioning data D.

The point A is, for example, the latest positioning point q₃₀ among the positioning points q₁ to q₃₀ included in the positioning data D. When a failure flag for the positioning point q₃₀ indicates “0”, the latest positioning point for which a failure flag indicates “1” becomes the point A. The point B is among the positioning points q₁ to q₃₀ included in the positioning data D and is, for example, the positioning point q₂₉ measured immediately before the measurement of the point A. When a failure flag for the positioning point q₂₉ indicates “0”, the latest positioning point that has been measured immediately before the measurement of the point A and for which a failure flag indicates “1” becomes the point B.

The point C is, for example, the oldest positioning point q₁ among the positioning points q₁ to q₃₀ included in the positioning data D. When a failure flag for the positioning point q₁ indicates “0”, the oldest positioning point for which a failure flag indicates “1” becomes the point C. Arbitrary points among the positioning points q₁ to q₃₀ included in the positioning data D may be set as the points A, B, and C.

Then, the calculating unit 702 calculates the magnitude r_{BA} (=|V_{BA}|) of a vector V_{BA} extending from the point B to the point A and the magnitude r_{CA} (=|V_{CA}|) of a vector V_{CA} extending from the point C to the point A, based on coordinate values of latitudes and longitudes of the acquired points A, B, and C. The calculating unit 702 calculates an angle of the vector V_{BA} with respect to the reference direction as a local angle θ_{BA}. The calculating unit 702 calculates an angle of the vector V_{CA} with respect to the reference direction as a global angle θ_{CA}. The reference direction is the same as the reference direction set in the preprocess.

The extracting unit 703 extracts, from the high-accuracy MM result DB 220, a traveling data item d including the position of the vehicle Cr in a range search region R including any of the multiple positions indicated by the positioning data D. For example, the extracting unit 703 sets the range search region R including the latest positioning point q₃₀ (point A) among the positioning points q₁ to q₃₀.

The range search region R may be set at an arbitrary range. The range search region R is, for example, a range formed in a predetermined shape (for example, a square, a rectangle, or a circle) and including the point A as the center of the range. For example, the range search region has a side of “several tens of meters” (in a vertical direction) and a side of several tens of meters (in a horizontal direction)” or has a “radius of several tens of meters” or the like. The range search region R may be a section that includes the point A and is any of sections obtained by dividing a map. For example, the sections are regions, each of which has a side of several tens of meters (in the vertical direction) or the like and a side of several tends of meters (in the horizontal direction) or the like.

Then, the extracting unit 703 extracts, from the high-accuracy MM result DB 220, traveling data items d including the position of the vehicle in the set range search region R. For example, the extracting unit 703 extracts, from the high-accuracy MM result DB 220, traveling data items d in which the latest positioning point p₃₀ (point a) among positioning points p₁ to p₃₀ of each of the traveling data items d is included in the range search region R (range search).

Thus, the range search may be executed based on the latest positioning point q₃₀ (point A) indicated by the positioning data D to narrow down the traveling data items d to traveling data items d serving as candidate records upon the similarity search.

The searching unit 704 searches for a traveling data item d corresponding to the positioning data D from the high-accuracy MM result DB 220. For example, the searching unit 704 searches for the traveling data item d corresponding to the positioning data D from the extracted traveling data items d, based on either or both of the calculated local angle θ_{BA} of the positioning data D and the calculated global angle θ_{CA} of the positioning data D.

The case where the traveling data item d corresponding to the positioning data D is searched for based on the local angle θ_{BA} of the positioning data D is described below. In this case, first, the searching unit 704 determines whether or not the magnitude r_{BA} of the vector V_{BA} is larger than a positioning error E. The positioning error E is, for example, a GPS positioning error included in the position measured using the GPS.

The positioning error E may be set at an arbitrary value. For example, the positioning error E may be set at several tens of meters or the like. The positioning error E may be set at 3σ (σ is a standard deviation of an error distribution). Since effects of multipath and the like vary depending on a location, a positioning error E may be set for each of the sections arranged in a mesh form by dividing the map.

When the magnitude r_{BA} of the vector V_{BA} is larger than the positioning error E, the searching unit 704 sets a local angular range “θ_{BA}±θ′_{BA}”, based on the local angle θ_{BA}. “θ_{BA}±θ′_{BA}” indicates an angular range that is equal to or larger than “θ_{BA}−θ′_{BA}” and equal to or smaller than “θ_{BA}+θ′_{BA}”. θ′_{BA} may be set at an arbitrary value. For example, θ′_{BA} may be a fixed value of 45 degrees or the like. θ′_{BA} may be calculated based on the magnitude r_{BA} of the vector V_{BA}.

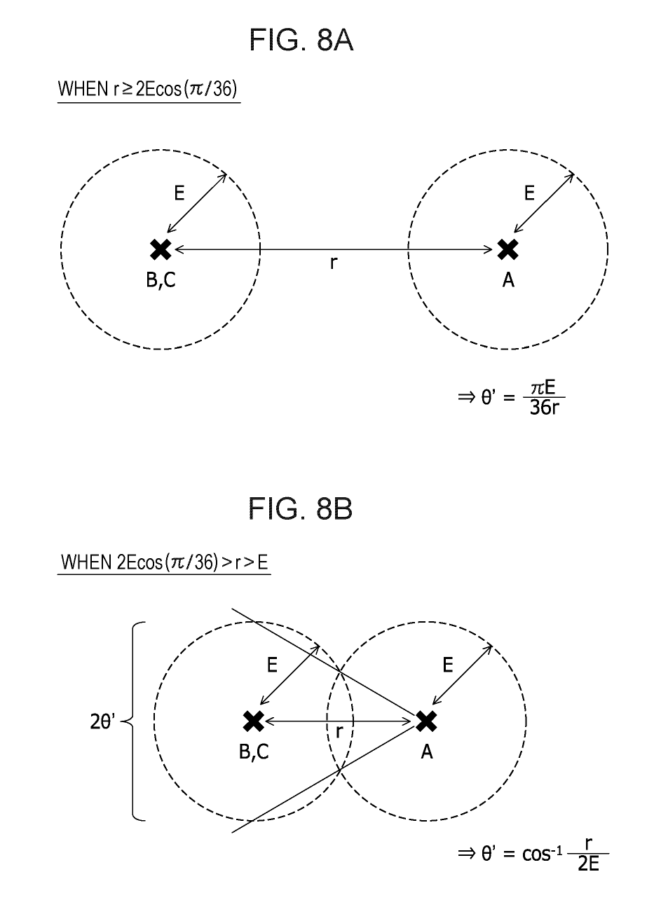

An example of the calculation of the local angular range “θ_{BA}±θ′_{BA}” is described with reference to FIGS. 8A and 8B.

FIGS. 8A and 8B are explanatory diagrams illustrating relationships between the magnitude r of a vector V and the positioning error E. As illustrated in FIG. 8A, when the magnitude r_{BA} of the vector V_{BA} is equal to or larger than 2E cos(π/36), the searching unit 704 may use the following Equation (1) to calculate θ′_{BA} of the local angular range “θ_{BA}±θ′_{BA}”. In this case, in Equation (1), θ′ indicates θ′_{BA}, and r indicates r_{BA}.

θ′=πE/36r (1)

As illustrated in FIG. 8B, when the magnitude r_{BA} of the vector V_{BA} is larger than E and smaller than 2E cos(π/36), the searching unit 704 may use the following Equation (2) to calculate θ′_{BA} of the local angular range “θ_{BA}±θ′_{BA}”. In this case, in Equation (2), θ′ indicates θ′_{BA}, and r indicates r_{BA}.

θ′=cos⁻¹(r/2E) (2)

Thus, θ′_{BA} may be calculated from relationships between the distance (r_{BA}) between the point A and the point B and the positioning error E. However, when θ′_{BA} is too small, the local angular range “θ_{BA}±θ′_{BA}” becomes too narrow. In this case, the minimum value of θ′_{BA} may be set. For example, the minimum value of θ′_{BA} may be set at 5 degrees or the like. In this case, when “θ′_{BA}<5 degrees”, θ′_{BA} is set at “5 degrees”.

Return to the description of FIG. 7. The searching unit 704 searches for, from the extracted traveling data items d, a traveling data item d in which a local angle θ_{ba} is in the local angular range “θ_{BA}±θ′_{BA}” or the range equal to or larger than “θ_{BA}−θ′_{BA}” and equal to or smaller than “θ_{BA}+θ′_{BA}”. Thus, the traveling data items d may be narrowed down to traveling data items d indicating a local movement direction similar to that of the positioning data D.

When the magnitude r_{BA} of the vector V_{BA} is equal to or smaller than the positioning error E, an effect of the positioning error E on the vector V_{BA} is large and it is difficult to determine a local movement direction of the vehicle Cr. Thus, when the magnitude r_{BA} of the vector V_{BA} is equal to or smaller than the positioning error E, the traveling data items d may not be narrowed down using the local angle θ_{BA} of the positioning data D.

Next, the case where the traveling data item d corresponding to the positioning data D is searched for based on the global angle θ_{CA} of the positioning data D is described. In this case, first, the searching unit 704 determines whether or not the magnitude r_{CA} of the vector V_{CA} is larger than the positioning error E.

When the magnitude r_{CA} of the vector V_{CA} is larger than the positioning error E, the searching unit 704 sets the global angular range “θ_{CA}±θ′_{CA}”, based on the global angle θ_{CA}. θ′_{CA} may be set at an arbitrary value. For example, θ′_{CA} may be set at a fixed value of 10 degrees or the like. θ′_{CA} may be calculated based on the magnitude r_{CA} of the vector V_{CA}.

An example of the calculation of θ′_{CA} of the global angular range “θ_{CA}±θ′_{CA}” is described with reference to FIGS. 8A and 8B. As illustrated in FIG. 8A, when the magnitude r_{CA} of the vector V_{CA} is equal to or smaller than 2E cos(π/36), the searching unit 704 may use the aforementioned Equation (1) to calculate θ′_{CA} of the global angular range “θ_{CA}±θ′_{CA}”. In this case, in Equation (1), θ′ indicates θ′_{CA}, and r indicates r_{CA}.

As illustrated in FIG. 8B, when the magnitude r_{CA} of the vector V_{CA} is larger than E and smaller than 2E cos(π/36), the searching unit 704 may use the aforementioned Equation (2) to calculate θ′_{CA} of the global angular range “θ_{CA}+θ′_{CA}”. In this case, in Equation (2), θ′ indicates θ′_{CA} and r indicates r_{CA}.

Thus, θ′_{CA} may be calculated from relationships between the distance (r_{CA}) between the point A and the point C and the positioning error E. When θ′_{CA} is too small, the global angular range “θ_{CA}±θ′_{CA}” becomes too narrow. In this case, the minimum value of θ′_{CA} may be set. For example, the minimum value of θ′_{CA} may be set at 5 degrees or the like. In this case, when “θ′_{CA}<5 degrees”, θ′_{CA} is set at “5 degrees”.

Then, the searching unit 704 searches for a traveling data item d in which a global angle θ_{ca} is in the global angular range “θ_{CA}±θ′_{CA}” or the range equal to or larger than “θ_{CA}−θ′_{CA}” and equal to or smaller than “θ_{CA}+θ′_{CA}”. Thus, the traveling data items d may be narrowed down to traveling data items d indicating a global movement direction similar to that of the positioning data D.

When the magnitude r_{CA} of the vector V_{CA} is equal to or smaller than the positioning error E, an effect of the positioning error E on the vector V_{CA} is large and it is difficult to determine a global movement direction of the vehicle Cr. Thus, when the magnitude r_{CA} of the vector V_{CA} is equal to or smaller than the positioning error E, the traveling data items d may not be narrowed down using the global angle θ_{CA} of the positioning data D.

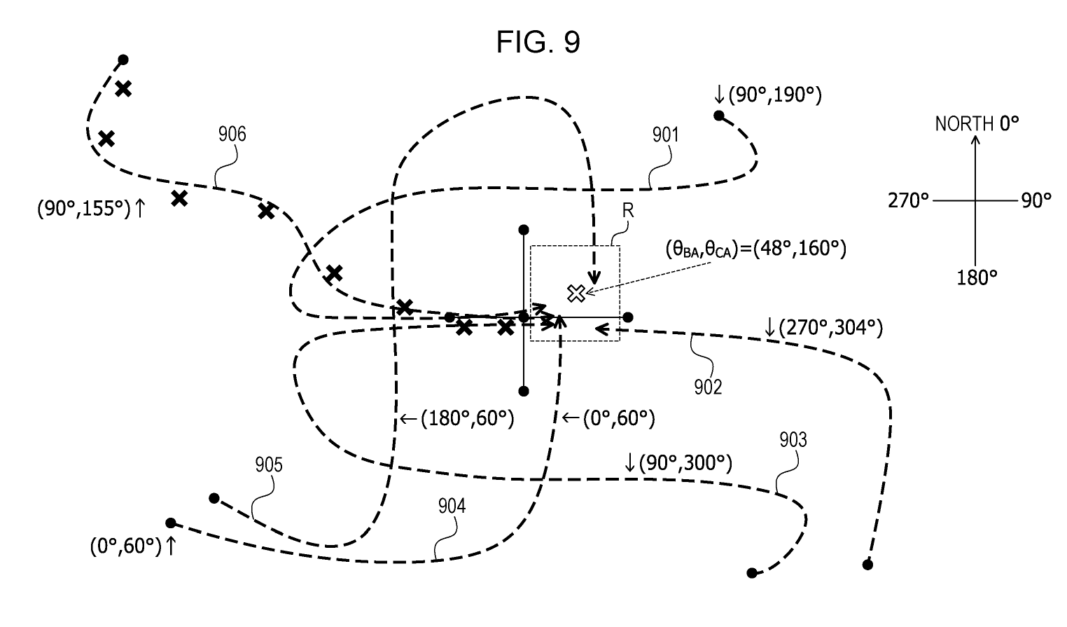

In the following description, a traveling data item d searched for by the searching unit 704 is referred to as “traveling data item dk” in some cases (k=1, 2, . . . ). An example of the search of the traveling data item d is described later with reference to FIG. 9.

The identifying unit 705 identifies a road associated with the positions indicated by the positioning data D, based on the searched traveling data item dk. For example, the identifying unit 705 calculates a similarity between the traveling data item dk and the positioning data D. In this case, the similarity may be calculated from Euclidean distances between positioning points p indicated by the traveling data item dk and the positioning points q indicated by the positioning data D.

For example, the identifying unit 705 may use the following Equation (3) to calculate a non-similarity NR^{(k)} between the traveling data item dk and the positioning data D. An inverse of the non-similarity NR^{(k)} corresponds to the similarity between the traveling data item dk and the positioning data D.

As indicated by the following Equation (4), (xᵢ, yᵢ) indicates coordinates of an i-th positioning point qᵢ from the top positioning point among the positioning points q₁ to q₃₀ indicated by the positioning data D (i=1, 2, . . . , N). wᵢ indicates a failure flag for a positioning point qᵢ. (X^{(k)}ᵢ, Y^{(k)}ᵢ) indicates coordinates of an i-th positioning point pᵢ from the top positioning point among the positioning points p₁ to p_{N} indicated by the traveling data item dk, as indicated by the following Equation (5).

$$\begin{matrix}{NR}^{( k )} = {\sum }_{i = 1}^{N} {w}_{i} ( {( {x}_{i} - {X}_{i}^{( k )} )}^{2} + {( {y}_{i} - {Y}_{i}^{( k )} )}^{2} ) & ( 3 ) \\ ( {q}_{1} , {q}_{2} , ⋯ , {q}_{N} ) = \{ ( {x}_{1} , {y}_{1} ) , ( {x}_{2} , {y}_{2} ) , ⋯ , ( {x}_{N} , {y}_{N} ) & ( 4 ) \\ ( {p}_{1} , {p}_{2} , ⋯ , {p}_{N} ) = \{ ( {x}_{1}^{( k )} , {y}_{1}^{( k )} ) , ( {x}_{2}^{( k )} , {y}_{2}^{( k )} ) , ⋯ , ( {x}_{N}^{( k )} , {y}_{N}^{( k )} ) & ( 5 )\end{matrix}$$

Then, the identifying unit 705 identifies roads associated with the positions indicated by the positioning data D, based on the calculated non-similarity NR^{(k)}. For example, when the calculated non-similarity NR^{(k)} is equal to or smaller than a threshold a, the identifying unit 705 references the high-accuracy MM result DB 220 and may identify roads indicated by road data (road ID array) associated with the traveling data item dk as roads associated with the positioning points q indicated by the positioning data D.

When the calculated non-similarity NR^{(k)} is equal to or greater than the threshold a, the identifying unit 705 does not identify roads associated with the positions indicated by the positioning data D. The threshold a may be set at an arbitrary value. When a traveling data item dk similar to the positioning data D does not exist, the roads associated with the positions indicated by the positioning data D may not be identified, thereby preventing the accuracy of the map matching from being reduced.

When multiple traveling data items d are searched for, the identifying unit 705 may identify roads indicated by road data (road ID array) associated with a traveling data item dk of which a calculated non-similarity NR^{(k)} is the smallest as the roads associated with the positions indicated by the positioning data D. When the minimum non-similarity NR^{(k)} is larger than the threshold a, the roads associated with the positions indicated by the positioning data D may not be identified.

Thus, roads indicated by road data (road ID array) associated with a traveling data item dk that is the most similar data to the positioning data D may be identified as the roads associated with the positioning points q indicated by the positioning data D, while preventing the accuracy of the map matching from being reduced.

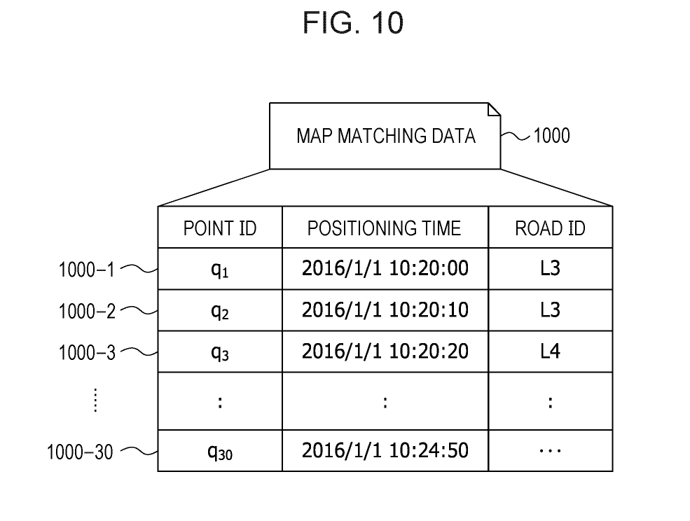

The output unit 706 associates the positions indicated by the positioning data D with the roads associated with the identified positions and outputs data indicating the positions and the roads. For example, the output unit 706 may output map matching data 1000 in which positioning time when the position indicated by the positioning data D has been measured is associated with the road associated with the identified position, as illustrated in FIG. 10 described later.

As the output of the data by the output unit 706, the data may be stored in a storage device such as the memory 302 or the disk 305, or transmitted to an external computer via the I/F 303, or the like.

(Example of Search of Traveling Data d)

Next, an example of the search of a traveling data item d is described with reference to FIG. 9.

FIG. 9 is a diagram describing an example of the search of a traveling data item d. In FIG. 9, a white symbol x indicates the latest positioning point (point A) of the positioning data D, and black symbols x indicate positioning points indicated by the positioning data D and excluding the latest positioning point of the positioning data D. Traveling data items 901 to 906 are obtained by the range search and include latest positioning points in a range search region R.

This case assumes that the local angle θ_{BA} of the positioning data D is “48 degrees”, the global angle θ_{CA} of the positioning data D is “160 degrees”, θ′_{BA} is “45 degrees”, and θ′_{CA} is “10 degrees”. In this case, “3 degrees≤the local angular range “θ_{BA}±θ′_{BA}”≤93 degrees, and “150 degrees≤the global angular range “θ_{CA}±θ′_{CA}”≤170 degrees”.

The case where a traveling data item d in which a local angle θ_{ba} is in the local angular range of “3 degrees to 93 degrees” and a global angle θ_{ca} is in the global angular range of “150 degrees to 170 degrees” is searched for from the traveling data items 901 to 906 is described.

A local angle θ_{ba} of the traveling data item 901 and a global angle θ_{ca} of the traveling data item 901 are “90 degrees and 190 degrees”, respectively. Thus, since the global angle θ_{ca} is out of the global angular range in the traveling data item 901, the traveling data item 901 is excluded (or is not searched for).

A local angle θ_{ba} of the traveling data item 902 and a global angle θ_{ca} of the traveling data item 902 are “270 degrees and 304 degrees”, respectively. Thus, since the local and global angles θ_{ba} and θ_{ca} are out of the local and global angular ranges in the traveling data item 902, the traveling data item 902 is excluded (or is not searched for).

A local angle θ_{ba} of the traveling data item 903 and a global angle θ_{ca} of the traveling data item 903 are “90 degrees and 300 degrees”, respectively. Thus, since the global angle θ_{ca} is out of the global angular range in the traveling data item 903, the traveling data item 903 is excluded (or is not searched for).

A local angle θ_{ba} of the traveling data item 904 and a global angle θ_{ca} of the traveling data item 904 are “0 degrees and 60 degrees”, respectively. Thus, since the local and global angles θ_{ba} and θ_{ca} are out of the local and global angular ranges in the traveling data item 904, the traveling data item 904 is excluded (or is not searched for).

A local angle θ_{ba} of the traveling data item 905 and a global angle θ_{ca} of the traveling data item 905 are “180 degrees and 60 degrees”, respectively. Thus, since the local and global angles θ_{ba} and θ_{ca} are out of the local and global angular ranges in the traveling data item 905, the traveling data item 905 is excluded (or is not searched for).

A local angle θ_{ba} of the traveling data item 906 and a global angle θ_{ca} of the traveling data item 906 are “90 degrees and 155 degrees”, respectively. Thus, the local and global angles θ_{ba} and θ_{ca} are in the local and global angular ranges in the traveling data item 906, the traveling data item 906 is searched for.

In the example illustrated in FIG. 9, only the traveling data item 906 is searched for from the traveling data items 901 to 906. As a result, since the traveling data items 901 to 905 of which local and global movement directions are not similar to those of the positioning data D are excluded in the similarity search, a time period required for the similarity calculation and a load caused by the similarity calculation may be reduced.

(Specific Example of Map Matching Data 1000)

FIG. 10 is an explanatory diagram illustrating an example of the map matching data 1000. In FIG. 10, the map matching data 1000 includes fields for point IDs, positioning time, and road IDs. Map matching results 1000-1 to 1000-30 are stored as records by setting information in the fields.

The point IDs are identifiers identifying the positioning points q. The positioning time is time and dates when the positions of the positioning points q have been measured. The road IDs are identifiers identifying roads associated with the positions of the positioning points q. A road on which a certain vehicle Cr has traveled and time when the certain vehicle Cr has traveled on the road may be identified from the map matching data 1000. The map matching data 1000 may be used to recognize states of roads in real time.

The map matching data 1000 may include coordinates (latitudes and longitudes) of the positioning points q. The map matching data 1000 may include identification information identifying the vehicles Cr or the terminal devices T attached to the vehicles Cr. Identification information identifying the vehicles Cr or identification information identifying the terminal devices T may be included in the positioning data D, for example. Thus, a vehicle Cr that has traveled on a road, the road, and time (positioning time) when the vehicle Cr has traveled on the road may be identified.

(Process Procedures of Information Processing Device 101)

Next, various process procedures of the information processing device 101 are described.

<Preprocess>

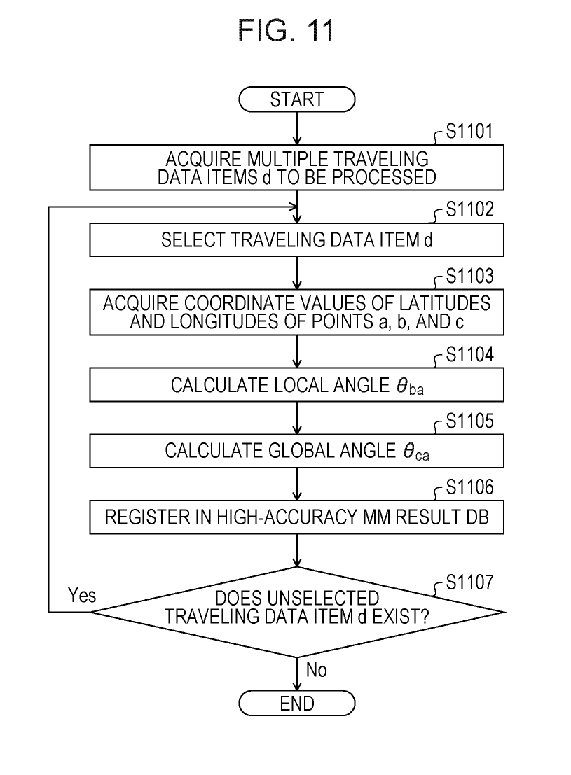

First, a preprocess procedure of the information processing device 101 is described with reference to FIG. 11. The preprocess is periodically executed at predetermined time intervals of 24 hours or the like, for example.

FIG. 11 is a flowchart of an example of the preprocess procedure of the information processing device 101. In the flowchart of FIG. 11, first, the information processing device 101 acquires multiple traveling data items d to be processed (in step S1101). The traveling data items d are associated with road data st.

Then, the information processing device 101 selects an unselected traveling data item d from among the multiple traveling data items d to be processed (in step S1102). Then, the information processing device 101 acquires, from the selected traveling data item d, coordinate values of latitudes and longitudes of points a, b, and c (in step S1103).

The information processing device 101 calculates a local angle θ_{ba} of a vector v_{ba} extending from the point b to the point a with respect to the reference direction, based on the acquired coordinate values of the latitudes and longitudes of the points a and b (in step S1104). The information processing device 101 calculates a global angle θ_{ca} of a vector v_{ca} extending from the point c to the point a with respect to the reference direction, based on the coordinate values of the latitudes and longitudes of the points a and c (in step S1105).

The information processing device 101 associates the calculated local angle θ_{ba} and the calculated global angle θ_{ca} with the selected traveling data item d and registers the calculated local angle θ_{ba}, the calculated global angle θ_{ca}, and the selected traveling data item d in the high-accuracy MM result DB 220 (in step S1106). The information processing device 101 determines whether or not an unselected traveling data item d exists among the multiple traveling data items d to be processed (in step S1107).

When the unselected traveling data item d exists (Yes in step S1107), the information processing device 101 causes the preprocess to return to step S1102. When the unselected traveling data item d does not exist (No in step S1107), the information processing device 101 terminates the preprocess of the flowchart illustrated in FIG. 11.

Thus, the local angle θ_{ba} indicating a local movement direction indicated by the traveling data item d and the global angle θ_{ca} indicating a global movement direction indicated by the traveling data item d may be associated with the traveling data item d and registered in the high-accuracy MM result DB 220.

<Real-Time Process Procedure>

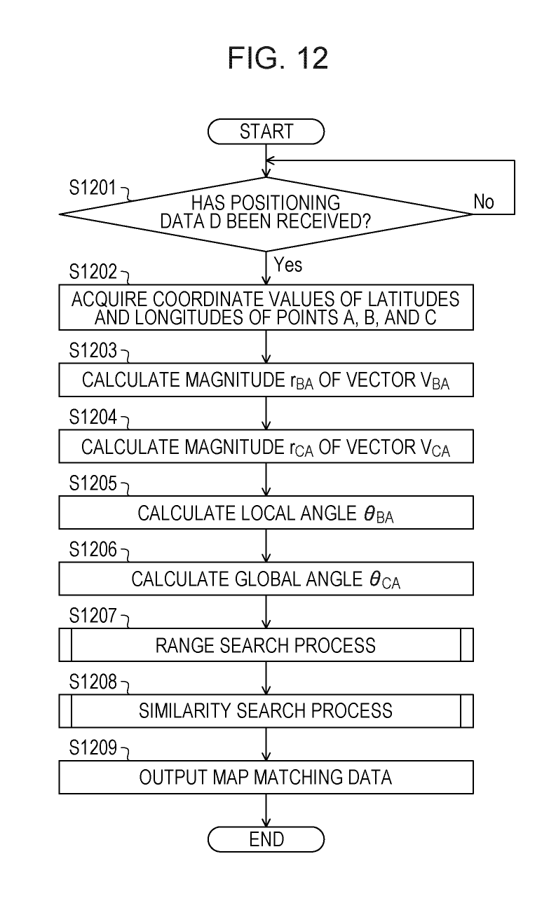

Next, a real-time process procedure of the information processing device 101 is described with reference to FIG. 12.

FIG. 12 is a flowchart illustrating an example of the real-time process procedure of the information processing device 101. In the flowchart of FIG. 12, first, the information processing device 101 determines whether or not the information processing device 101 has received positioning data D indicating chronological changes in the position of a vehicle Cr from a terminal device T attached to the vehicle Cr (in step S1201).

The information processing device 101 waits to receive the positioning data D (No in step S1201). When the information processing device 101 has received the positioning data D (Yes in step S1201), the information processing device 101 acquires coordinate values of latitudes and longitudes of points A, B, and C from the positioning data D (in step S1202).

The information processing device 101 calculates the magnitude r_{BA} of a vector V_{BA} extending from the point B to the point A, based on the acquired coordinate values of the latitudes and longitudes of the points A and B (in step S1203). The information processing device 101 calculates the magnitude r_{CA} of a vector V_{CA} extending from the point C to the point A, based on the acquired coordinate values of the latitudes and longitudes of the points A and C (in step S1204).

The information processing device 101 calculates a local angle θ_{BA} of the vector V_{BA} with respect to the reference direction (in step S1205). The information processing device 101 calculates a global angle θ_{CA} of the vector V_{CA} with respect to the reference direction (in step S1206).

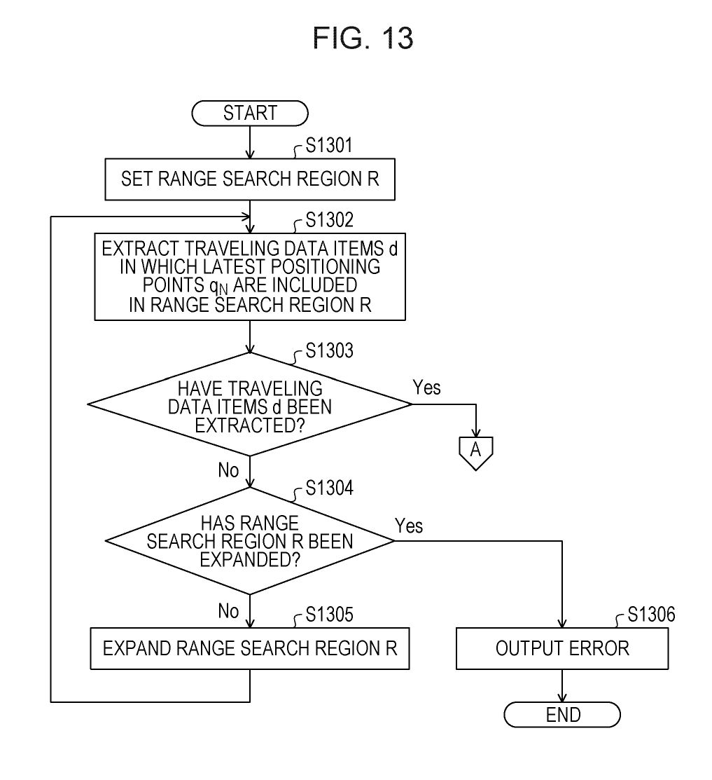

The information processing device 101 executes the range search, based on positions indicated by the positioning data D, the magnitude r_{BA} of the vector V_{BA}, the magnitude r_{CA} of the vector V_{CA}, the local angle θ_{BA}, and the global angle θ_{CA} (in step S1207). An example of a procedure for the range search process is described later with reference to FIGS. 13 to 15.

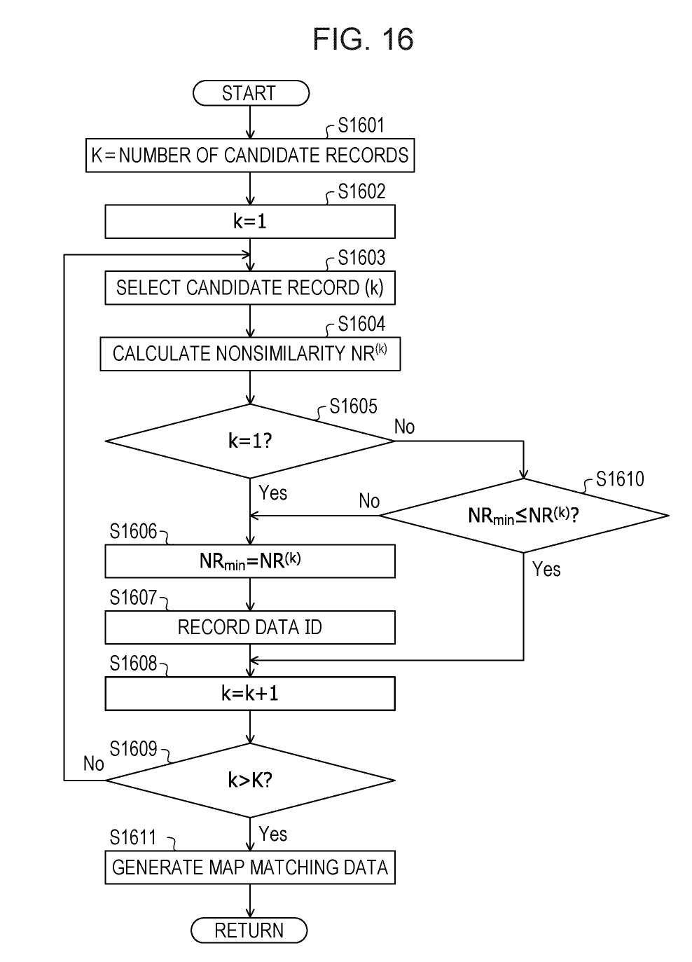

The information processing device 101 executes the similarity search process, based on candidate records (traveling data items d) obtained by the range search process (in step S1208). An example of a procedure for the similarity search process is described later with reference to FIG. 16. The information processing device 101 outputs map matching data obtained by the similarity search process (in step S1209) and terminates the real-time process of the flowchart illustrated in FIG. 12.

Thus, the map matching data, which is results of executing the map matching on the positions (positioning points q₁ to q_{N}), indicated by the positioning data D, of the vehicle Cr is output.

Procedure for Range Search Process

An example of a procedure for the range search process of step S1207 illustrated in FIG. 12 is described with reference to FIGS. 13 to 15.

FIGS. 13 to 15 are flowcharts illustrating an example of the specific procedure for the range search process. In the flowchart of FIG. 13, the information processing device 101 sets a range search region R including the latest positioning point q_{N} (point A) among the positioning points q1 to q_{N} of the positioning data D (in step S1301).

The information processing device 101 extracts, from the high-accuracy MM result DB 220, traveling data items d in which the latest positioning points q_{N} among the positioning points q₁ to q_{N} are included in the set range search region R (in step S1302). The information processing device 101 determines whether or not the traveling data items d have been extracted (in step S1303).

When the traveling data items d have not been extracted (No in step S1303), the information processing device 101 determines whether or not the range search region R has been expanded (in step S1304). When the range search region R has not been expanded (No in step S1304), the information processing device 101 expands the range search region R (in step S1305) and causes the range search process to return to step S1302.

A method of expanding the range search region R may be arbitrary. For example, the information processing device 101 may multiply lengths of vertical and horizontal sides of the range search region R by β to expand the range search region R. β is a value greater than 1. For example, β is set at 4/3 or the like.

When the range search region R has been expanded (Yes in step S1304), the information processing device 101 outputs an error (in step S1306) and terminates the range search process of the flowchart illustrated in FIG. 13. The error indicates that the map matching of the positioning data D has failed.

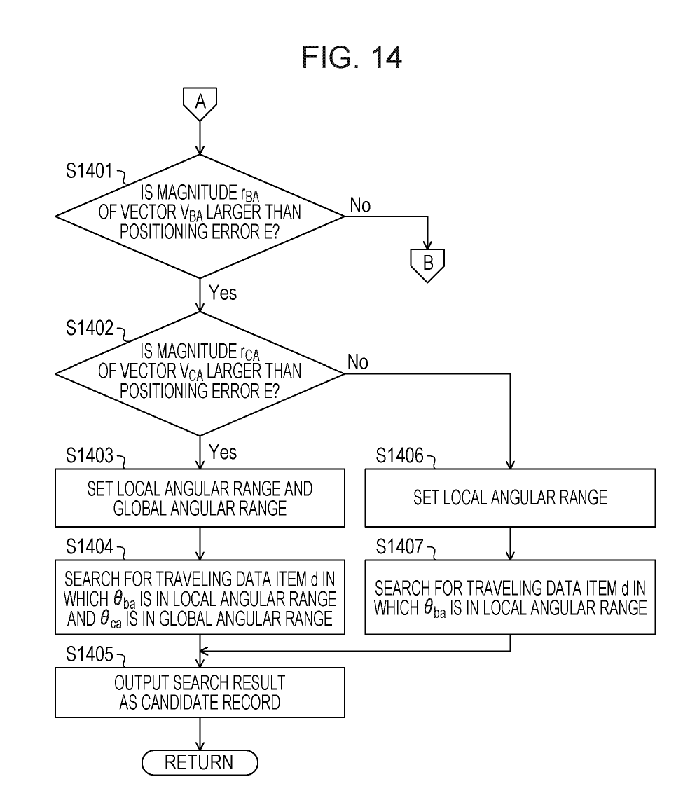

When the traveling data items d have been extracted (Yes in step S1303), the information processing device 101 causes the range search process to proceed to step S1401 illustrated in FIG. 14.

In the flowchart illustrated in FIG. 14, the information processing device 101 determines whether or not the magnitude r_{BA} of the vector V_{BA} is larger than the positioning error E (in step S1401). When the magnitude r_{BA} is larger than the positioning error E (Yes in step S1401), the information processing device 101 determines whether or not the magnitude r_{CA} of the vector V_{CA} is larger than the positioning error E (in step S1402).

When the magnitude r_{CA} is larger than the positioning error E (Yes in step S1402), the information processing device 101 sets a local angular range “θ_{BA}±θ′_{BA}” and a global angular range “θ_{CA}±θ′_{CA}” (in step S1403).

The information processing device 101 searches for, from the extracted traveling data items d, a traveling data item d in which a local angle θ_{ba} is in the local angular range “θ_{BA}±θ′_{BA}” and a global angle θ_{ca} is in the global angular range “θ_{CA}±θ′_{CA}” (in step S1404). The information processing device 101 outputs a result of the search as a candidate record (in step S1405) and causes the real-time process to return to the step from which the range search process has been called.

When the magnitude r_{CA} is equal to or smaller than the positioning error E (No in step S1402), the information processing device 101 sets the local angular range “θ_{BA}±θ′_{BA}” (in step S1406). The information processing device 101 searches for, from the extracted traveling data items d, a traveling data item d in which a local angle θ_{ba} is in the local angular range “θ_{BA}±θ′BA” (in step S1407), and causes the range search process to proceed to step S1405.

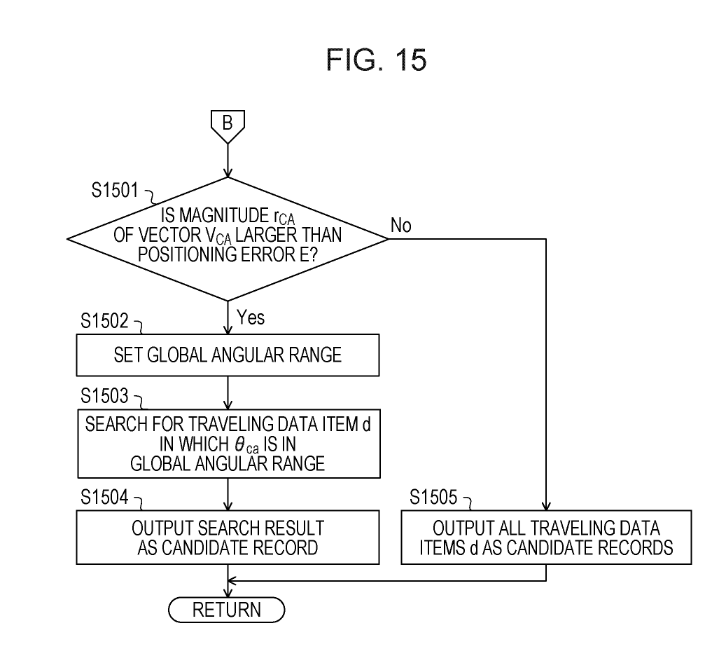

When the magnitude r_{BA} is equal to or smaller than the positioning error E (No in step S1401), the information processing device 101 causes the range search process to step S1501 illustrated in FIG. 15.

In the flowchart illustrated in FIG. 15, the information processing device 101 determines whether or not the magnitude r_{CA} of the vector V_{CA} is larger than the positioning error E (in step S1501). When the magnitude r_{CA} is larger than the positioning error E (Yes in step S1501), the information processing device 101 sets the global angular range “θ_{CA}±θ′_{CA}” (in step S1502).

The information processing device 101 searches for, from the extracted traveling data items d, a traveling data item d in which a global angle θ_{ca} is in the global angular range “θ_{CA}±θ′_{CA}” (in step S1503). The information processing device 101 outputs a result of the search as a candidate record (in step S1504) and causes the real-time process to return to the step from which the range search process has been called.

When the magnitude r_{CA} is equal to or smaller than the positioning error E (No in step S1501), the information processing device 101 outputs all the extracted traveling data items d as candidate records (in step S1505) and causes the real-time process to return to the step from which the range search process has been called.

Thus, the traveling data items d obtained by the range search using the range search region R may be narrowed down to a traveling data item d indicating local and global movement directions similar to those of the positioning data D.

Procedure for Similarity Search Process

Next, an example of a procedure for the similarity search process of step S1208 illustrated in FIG. 12 is described with reference to FIG. 16.

FIG. 16 is a flowchart illustrating an example of a procedure for the similarity search process. In the flowchart illustrated in FIG. 16, first, the information processing device 101 sets the number of candidate records (traveling data items d) output in step S1207 as a value of a parameter K (in step S1601). In the following description, the candidate records output in step S1207 are referred to as “traveling data items (1) to (K)” (K is a natural number of 1 or more).

The information processing device 101 sets “k” at “1” (in step S1602) and selects a traveling data item (k) from among the traveling data items (1) to (K) (in step S1603). The information processing device 101 uses the aforementioned Equation (3) to calculate a non-similarity NR^{(k)} between the positioning data D and the traveling data item (k) (in step S1604).

The information processing device 101 determines whether or not “k=1” (in step S1605). When “k=1” (Yes in step S1605), the information processing device 101 sets the minimum non-similarity NRₘᵢₙ at NR^{(k)} (in step S1606). The information processing device 101 records a data ID of the traveling data item (k) (in step S1607). When the data ID is already registered, the information processing device 101 overwrites the data ID with a new data ID.

The information processing device 101 increments “k” by 1 (in step S1608) and determines whether or not “k” is larger than “K” (in step S1609). When “k” is equal to or smaller than “K” (No in step S1609), the information processing device 101 causes the similarity range process to return to step S1603.

When “k≠1” (No in step S1605), the information processing device 101 determines whether or not the calculated non-similarity NR₍ₖ₎ is equal to or larger than the minimum non-similarity NRₘᵢₙ (in step S1610).

When the non-similarity NR₍ₖ₎ is equal to or larger than the minimum non-similarity NRₘᵢₙ (Yes in step S1610), the information processing device 101 causes the similarity range process to proceed to step S1608. When the non-similarity NR₍ₖ₎ is smaller than the minimum non-similarity NRₘᵢₙ (No in step S1610), the information processing device 101 causes the similarity range process to proceed to step S1606.

When “k” is larger than “K” (Yes in step S1609), the information processing device 101 generates map matching data, based on road data associated with the traveling data item d of the recorded data ID (in step S1611) and causes the real-time process to return to the step from which the similarity search process has been called.

Thus, similarities between the positioning data D and candidate records (traveling data items d) may be calculated and the roads associated with the positioning points q₁ to q_{N} indicated by the positioning data D may be identified.

As described above, the information processing device 101 according to the embodiment may search for, from the high-accuracy MM result DB 220, a traveling data item d corresponding to positioning data D, based on positions indicated by the positioning data D and an angle of a movement direction identified from a pair of positions among the multiple positions indicated by the positioning data D with respect to the reference direction.

Thus, a traveling data item d corresponding to a movement direction identified from a pair of positions among the multiple positions indicated by the positioning data D may be searched for.

The information processing device 101 may extract, from the high-accuracy MM result DB 220, a traveling data item d including the position (for example, the latest positioning point p_{N}) of a vehicle in the range search region R including the point A among the positioning points q₁ to q₃₀ indicated by the positioning data D. The point A is, for example, the latest positioning point q_{N} among the positioning points q₁ to q₃₀ indicated by the positioning data D.

Thus, the range search may be executed based on the latest positioning point q_{N} (point A) indicated by the positioning data D to narrow down the traveling data items d to traveling data items d serving as the candidate records upon the similarity search.

The information processing device 101 may search for the traveling data item d corresponding to the positioning data D from the extracted traveling data items d, based on the angle (local angle θ_{BA}) of the vector V_{BA} extending from the point B to the point A among the positioning points q₁ to q_{N} indicated by the positioning data D. For example, the information processing device 101 sets the local angular range “θ_{BA}±θ′_{BA}”, based on the local angle θ_{BA}. The information processing device 101 searches for, from the extracted traveling data items d, a traveling data item d in which a local angle θ_{ba} of a vector v_{ba} extending from a point b to a point a among positioning points p₁ to p_{N} indicated by the traveling data item d with respect to the reference direction is in the local angular range “θ_{BA}±θ′_{BA}”.

Thus, the traveling data items d may be narrowed down to traveling data items d indicating local movement directions similar to that of the positioning data D. The point A is, for example, the latest positioning point q_{N} among the positioning points q₁ to q_{N} indicated by the positioning data D. The point B is among the positioning points q₁ to q_{N} indicated by the positioning data D and is, for example, a positioning point q_{(N-1)} measured immediately before the measurement of the point A. The point a is, for example, the latest positioning point p_{N} among the positioning points p₁ to p_{N} indicated by the traveling data item d. The point b is among the positioning points p₁ to p_{N} indicated by the traveling data item d and is, for example, a positioning point p_{(N-1)} measured immediately before the measurement of the point a.

When the magnitude r_{BA} of the vector V_{BA} is larger than the positioning error E, the information processing device 101 may search for the traveling data item d corresponding to the positioning data D among the extracted traveling data items d, based on the local angle θ_{BA}.

Thus, when an effect of the positioning error E on the vector V_{BA} is small, the traveling data items d may be narrowed down using the local angle θ_{BA}. In other words, when the effect of the positioning error E on the vector V_{BA} is large and it is difficult to determine a local movement direction of the vehicle Cr, the traveling data items d may not be narrowed down using the local angle θ_{BA}.

The information processing device 101 may search for the traveling data item d corresponding to the positioning data D among the extracted traveling data items d, based on the angle (global angle θ_{CA}) of the vector V_{CA} extending from the point C to the point A among the positioning points q₁ to q_{N} indicated by the positioning data D with respect to the reference direction. For example, the information processing device 101 sets the global angular range “θ_{CA}±θ′_{CA}”, based on the global angle θ_{CA}. Then, the information processing device 101 searches for, from the extracting traveling data items d, a traveling data item d in which a global angle θ_{ca} of a vector v_{ca} extending from a position c to a position a among positioning points p₁ to p_{N} indicated by the traveling data item d is in the global angular range “θ_{CA}±θ′_{CA}”.

Thus, the traveling data items d may be narrowed down to traveling data items d indicating global movement directions similar to that of the positioning data D. The point A is, for example, the latest positioning point q_{N} among the positioning points q₁ to q_{N} included in the positioning data D. The point C is, for example, the oldest positioning point q₁ among the positioning points q₁ to q_{N} included in the positioning data D. The point a is, for example, the latest positioning point p_{N} among positioning points p₁ to p_{N} included in the traveling data item d. The point c is, for example, the oldest point p₁ among the positioning points p₁ to p_{N} included in the traveling data item d.

When the magnitude r_{CA} of the vector v_{CA} is larger than the positioning error E, the information processing device 101 may search for the traveling data item d corresponding to the positioning data D from the extracted traveling data items d, based on the global angle θ_{CA}.

When an effect of the positioning error E on the vector v_{CA} is small, the traveling data items d may be narrowed down using the global angle θ_{CA}. In other words, when an effect of the positioning error E on the vector v_{CA} is large and it is difficult to determine a local movement direction of a vehicle Cr, the traveling data items d may not be narrowed down using the global angle θ_{CA}.

The information processing device 101 may use the aforementioned Equation (1) or (2) to set the local angular range “θ_{BA}±θ′_{BA}”, based on the local angle θ_{BA} and magnitude r_{BA} of the vector V_{BA}. Thus, θ′_{BA} may be calculated from relationships between the distance t(r_{BA}) between the point A and the point B and the positioning error E, and the local angular range “θ_{BA}±θ′_{BA}” may be set in a stepwise manner based on the distance (r_{BA}) relative to the positioning error E.

The information processing device 101 may use the aforementioned Equation (1) or (2) to set the global angular range “θ_{CA}±θ′_{CA}” based on the global angle θ_{CA} and magnitude r_{CA} of the vector V_{CA}. Thus, θ′_{CA} may be calculated from relationships between the distance (r_{CA}) between the point A and the point C and the positioning error E, and the global angular range “θ_{CA}±θ′_{CA}” may be set in a stepwise manner based on the distance (r_{CA}) relative to the positioning error E.

The information processing device 101 may calculate a non-similarity NR^{(k)} between a searched traveling data item dk and the positioning data D and identify the roads associated with the positions indicated by the positioning data D, based on the calculated non-similarity NR^{(k)}. Thus, the map matching may be executed using the similarity search.

When multiple traveling data items d are searched for, the information processing device 101 may identify, as the roads associated with the positions indicated by the positioning data D, roads indicated by road data (road ID array) associated with a traveling data item dk of which a calculated non-similarity NR^{(k)} is the smallest. Thus, roads indicated by road data associated with a traveling data item dk that is most similar to the positioning data D may be identified as roads associated with the positioning points q indicated by the positioning data D.

The information processing device 101 may associate positioning times when the positions indicated by the positioning data D have been measured with the roads associated with the identified positions. Then, the information processing device 101 may output data indicating the positioning times and the roads. Thus, a road on which a certain vehicle Cr has traveled and the time when the certain vehicle Cr has traveled on the road may be identified and the output data may be used to recognize the states of the roads in real time.

Thus, the information processing system 200 according to the embodiment may accurately execute the map matching in real time. In the map matching, it may be possible to reduce a time period required for the similarity calculation that tends to cause the largest cost during the entire process, reduce a load caused by the similarity calculation, and increase the number of vehicles to be processed in real time (or reduce a time period for the MM process per vehicle). As a result, it may be expected to increase, by several times to a dozen times, the number of vehicles to be processed by a single server (for example, the information processing device 101) in real time, and it may be possible to reduce the number of servers to be used for the map matching to a value in a range of a fraction of the number to a few percent of the number.

The information processing method described in the embodiment may be enabled by causing a computer such as a personal computer or a workstation to execute a program prepared in advance. The information processing program is recorded in a computer-readable recording medium such as a hard disk, a flexible disk, a CD-ROM, a magneto-optical (MO) disk, a digital versatile disc (DVD), or a Universal Serial Bus (USB) memory. The information processing program is read by the computer from the recording medium and executed by the computer. The information processing program may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory configured to store first traveling data items indicating chronological changes in positions of vehicles, in association with first angular information indicating an angle of a first movement direction of a vehicle with respect to a reference direction, the first movement direction being identified by a pair of positions among first multiple positions indicated by each of the first traveling data items; and
a processor coupled to the memory and configured to:
acquire positioning data indicating chronological changes in a measured position of a target vehicle, and
search for a target traveling data item corresponding to the positioning data from the memory, based on second multiple positions indicated by the acquired positioning data and second angular information indicating an angle of a second movement direction of the target vehicle with respect to the reference direction, the second movement direction being identified from a pair of positions among the second multiple positions indicated by the positioning data.

2. The information processing device of claim 1, wherein the processor is configured to:
extract, from the first traveling data items stored in the memory, second traveling data items that include positions of vehicles in a predetermined range including a first position among the second multiple positions indicated by the positioning data, and
search for the target traveling data item corresponding to the positioning data from the extracted second traveling data items, based on the second angular information indicating an angle of a first vector extending from a second position among the second multiple positions to the first position with respect to the reference direction, the second position being located before the first position in chronological order of the second multiple positions indicated by the positioning data.

3. The information processing device of claim 2, wherein:
the measured position of the target vehicle is measured using a satellite positioning system; and
when a magnitude of the first vector is larger than a predetermined positioning error included in the measured position of the target vehicle, the processor searches for the target traveling data item corresponding to the positioning data from the extracted second traveling data items, based on the second angular information.

4. The information processing device of claim 2, wherein the processor is configured to:
set a predetermined angular range, based on an angle of the first vector with respect to the reference direction, and
search for, from the extracted second traveling data items, the target traveling data item in which an angle of a second vector extending from a fourth position to a third position among the first multiple positions, the fourth position being located before the third position in chronological order of the first multiple positions indicated by each of the extracted second travelling data items.

5. The information processing device of claim 4, wherein:
the first position is located at a latest position in chronological order of the second multiple positions indicated by the positioning data;
the second position is located immediately before the first position in chronological order of the second multiple positions indicated by the positioning data;
the third position is located at a latest position in chronological order of the first multiple positions indicated by each of the second travelling data items; and
the fourth position is located immediately before the third position in chronological order of the first multiple positions indicated by each of the second travelling data items.

6. The information processing device of claim 4, wherein:
the first position is located at a latest position in chronological order of the second multiple positions indicated by the positioning data;
the second position is located at an oldest position in chronological order of the second multiple positions indicated by the positioning data;
the third position is located at a latest position in chronological order of the first multiple positions indicated by each of the second travelling data items; and
the fourth position is located at an oldest position in chronological order of the first multiple positions indicated by each of the second travelling data items.

7. The information processing device of claim 1, wherein:
the memory is further configured to store the first traveling data items in association with road data indicating roads corresponding to positions of the vehicles; and
the processor is further configured to:
calculate a similarity between each of the second traveling data items and the positioning data, and
identify roads corresponding to the second multiple positions indicated by the positioning data, based on the calculated similarity.

8. The information processing device of claim 7, wherein
the processor is configured to output data in which the identified roads corresponding to the second multiple positions indicated by the positioning data are associated with positioning times at which the second multiple positions have been measured.

9. The information processing device of claim 4, wherein
the processor is configured to set the predetermined angular range, based on an angle of the first vector with respect to the reference direction and a magnitude of the first vector.

10. The information processing device of claim 7, wherein the processor is configured to, when, as the target travelling data item, multiple traveling data items corresponding to the positioning data are searched for, identify, as the roads corresponding to the second multiple positions indicated by the positioning data, roads indicated by the road data associated with a traveling data item of which the calculated similarity is largest among the multiple traveling data items.

11. A method performed by a processor included in an information processing device, the method comprising:
providing a memory included in the information processing device with traveling data items indicating chronological changes in positions of vehicles, in association with first angular information indicating an angle of a first movement direction of a vehicle with respect to a reference direction, the first movement direction being identified by a pair of positions among first multiple positions indicated by each of the traveling data items;
acquiring positioning data indicating chronological changes in a measured position of a target vehicle; and
searching for a target traveling data item corresponding to the positioning data from the memory, based on second multiple positions indicated by the acquired positioning data and second angular information indicating an angle of a second movement direction of the target vehicle with respect to the reference direction, the second movement direction being identified from a pair of positions among the second multiple positions indicated by the positioning data.

12. A non-transitory, computer-readable recording medium having stored therein a program for causing a computer included in an information processing device to execute a process, the information processing device including a memory, the process comprising:
providing the memory with traveling data items indicating chronological changes in positions of vehicles, in association with first angular information indicating an angle of a first movement direction of a vehicle with respect to a reference direction, the first movement direction being identified by a pair of positions among first multiple positions indicated by each of the traveling data items;
acquiring positioning data indicating chronological changes in a measured position of a target vehicle; and
searching for a target traveling data item corresponding to the positioning data from the memory, based on second multiple positions indicated by the acquired positioning data and second angular information indicating an angle of a second movement direction of the target vehicle with respect to the reference direction, the second movement direction being identified from a pair of positions among the second multiple positions indicated by the positioning data.
